(19) United States
(12) Patent Application Publication
(10) Pub. No.: US 2008/0161968 A1
(43) Pub. Date: Jul. 3, 2008

(54) BT' Smart Machine (BTSM)

(76) Inventor: Babatunde Olanipekun Adegbile, (US)

Correspondence Address: BABATUNDE OLANIPEKUN ADEGBILE, 3812 WALES DR., DAYTON, OH, 45405, US

(21) Appl. No.: 11/618,927

(22) Filed: Jan. 1, 2007

(51) Int. Cl. G06F 19/00; A01D 34/00; A47L 9/00; B62D 55/18; G08B 13/14; H01R 11/00; E01H 5/00; F03G 6/00; G05D 3/00

(52) U.S. Cl. 700/245; 15/300.1; 290/1 R; 305/185; 340/571; 37/260; 439/504; 56/229; 701/24; 901/1

(57) ABSTRACT

A unique piece of engineering device “BT' Smart Machine” (BTSM) is described with the capability of lawn mowing, leave blowing/vacuuming, snow blowing, and general purpose blowing/vacuuming with other extra functionalities such as vehicle jump starter, heavy duty air compressor, vertical trolley, horizontal trolley, and outlets for AC and DC devices. BTSM' uniqueness lies in the fact that it can be run in manual (semi-automatic mode) or automatic mode (hands free mode). In manual mode (semi-automatic mode) BTSM anticipates and helps you along the way while in full-automatic mode BTSM does the work for you while you are home away from home or simply use that time to do something else and with a minimum of 10 to 12 hr uninhibited rechargeable battery life, BTSM has more than enough power to traverse your entire compound. In addition to all that, BTSM also runs off of solar energy which further maximizes battery life.

### BACKGROUND OF BTSM

I conceived this idea because I thought that it would be nice to have an all purpose machine that can be used indoors or outdoors. As we all know yard work can be quit a chore especially if you have tons of other responsibilities on your plate, and you still have to make time to do it otherwise you pay a hefty price by hiring someone to do it for you.

I then put up my thinking hat and pulled out my drawing board and after contemplating for a few hours, I came up with a rather ingenious idea. That is a smart little robot if you will I call “BT Smart Machine” (BTSM). With BTSM, your lawn can now be quietly mowed hands free and on schedule at all times. BTSM is virtually maintenance free as it is smart enough to open your garage door, mow the lawn (come rain or come sunshine), and re-park itself at the main base in your garage or on your porch so that it can charge up for the next job.

But wait, BTSM is not just an automated mower; it also doubles as a leaf blower/vacuum, a snow blower/shovel, or as an all purpose outdoor blower/vacuum. Unlike any other product that may be out there, BTSM has the capability of being run manually in any mode (vacuum, blower, mower, and you name it) so that you can get some exercise if you choose to. BTSM also has other potential uses that would be described in the bells and whistles section below. Because of BTSM' versatility and multipurpose abilities, this makes it stand out from anything else that may be out there which makes it worthy of a patent so please read along.

### BRIEF SUMMARY OF BTSM

The next generation smart robotic helper BTSM is depicted with the capability of lawn mowing, leave blowing/vacuuming, snow blowing, and general purpose blowing/vacuuming with other extra functionalities such as air compression.

BTSM is so unique and versatile in that it can be run in automatic mode (hands free mode) or semi-automatic mode (manual).

Allow BTSM to do all the work for you in full automatic mode, while you are away from home or while you use that time to do something else.

In manual mode (semi-automatic mode) you physically control BTSM, but it also anticipates and helps you just like an electric carpet vacuum that continually moves with a little push and stops with a little pull. Use the attachable unicycle stand (optional item) and hitch a ride while BTSM does the work or go without the attachable unicycle stand and get your daily exercise.

With a minimum of 10 to 12 hr uninhibited rechargeable battery life, BTSM has more than enough power to traverse your entire lawn and return to its base for charge-back once again. In addition to that BTSM also runs off of solar energy which further maximizes battery life.

For these reasons and many more to be discussed below, BTSM is truly a technological marvel that deserves a patent.

### A BRIEF DESCRIPTION OF BTSM PHOTOS

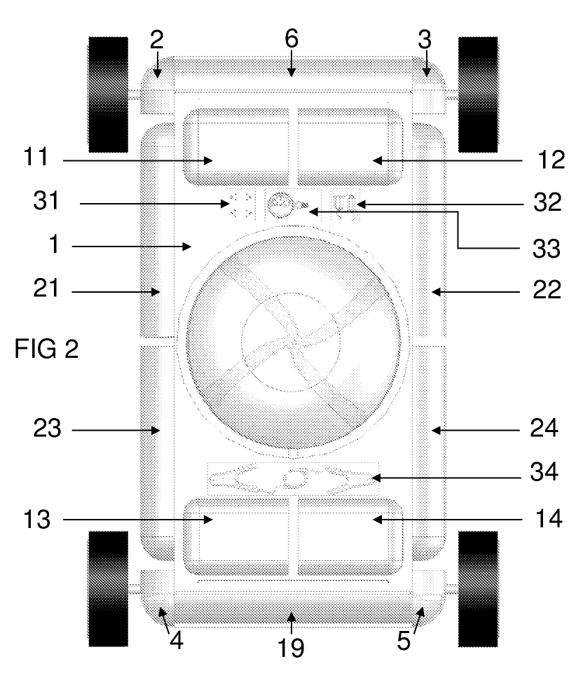

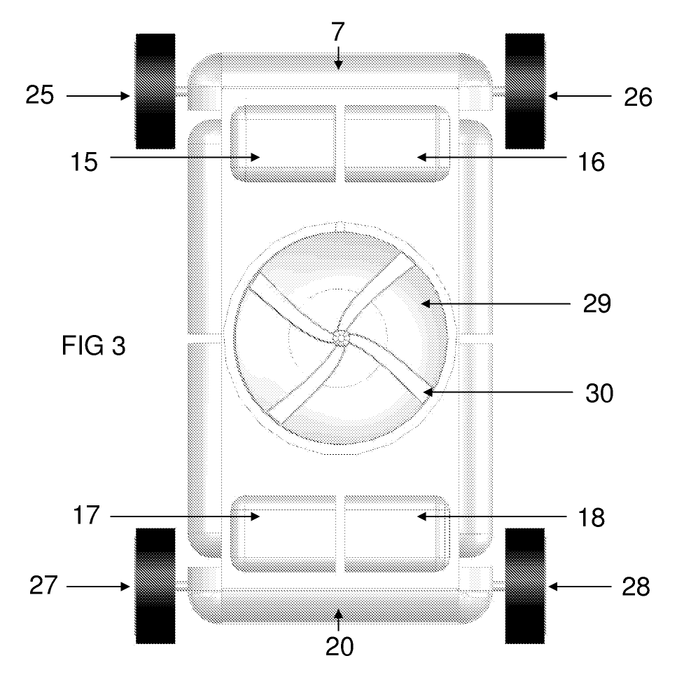

I have provided 60 clear digital images to help depict and illustrate what BTSM looks like and how it functions. FIGS. 2, 3, 8(b), 23, and 26 basically show all the important pieces that makeup BTSM and the rest of the Figures help to illustrate BTSM in action.

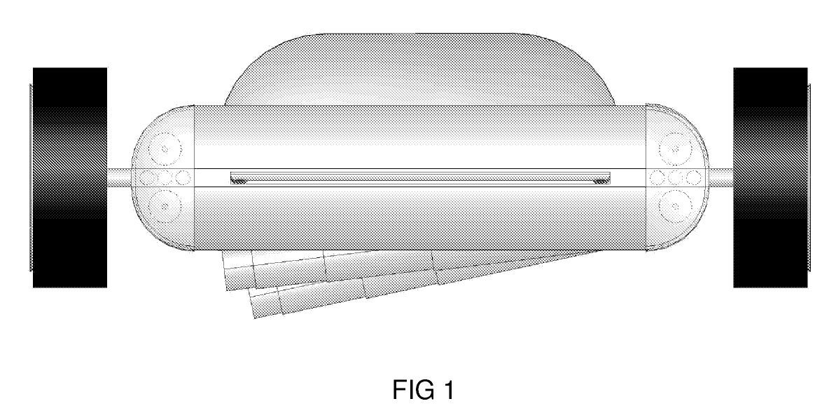

FIG. 1 depicts BTSM in front view, with 2 of 4 bottom actuator arms extended below.

FIG. 2 depicts BTSM in top view with some labeled parts; to be described later.

FIG. 3 depicts BTSM in bottom view with more labeled parts to be described later.

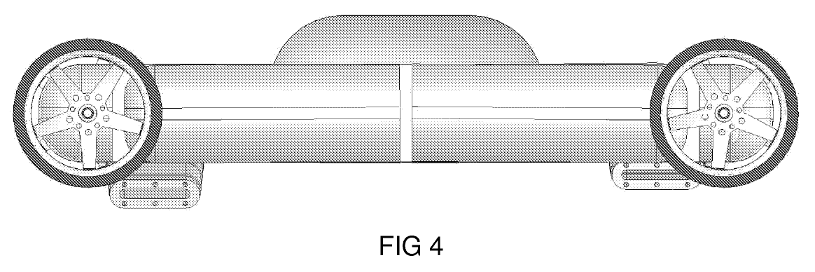

FIG. 4 depicts BTSM in side view (right side view).

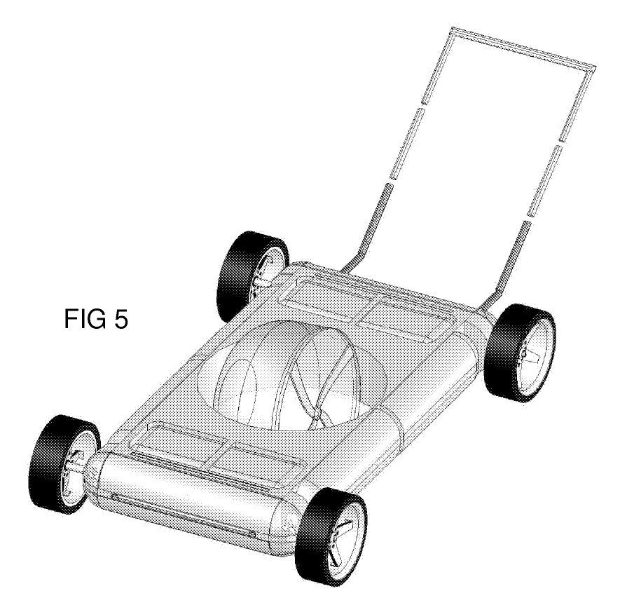

FIG. 5 depicts BTSM in trimetric view.

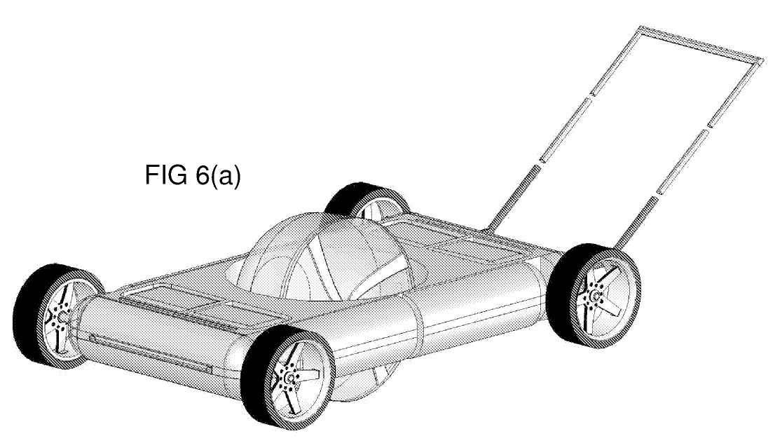

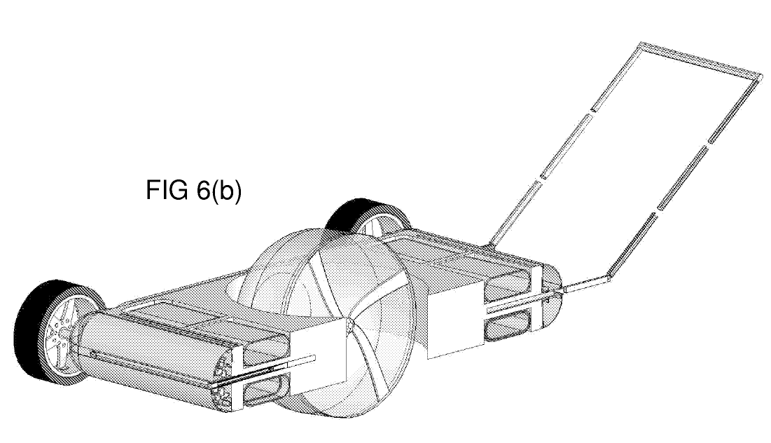

FIG. 6(a) depicts BTSM in dimetric view.

FIG. 6(b) depicts BTSM in diametric sectioned view.

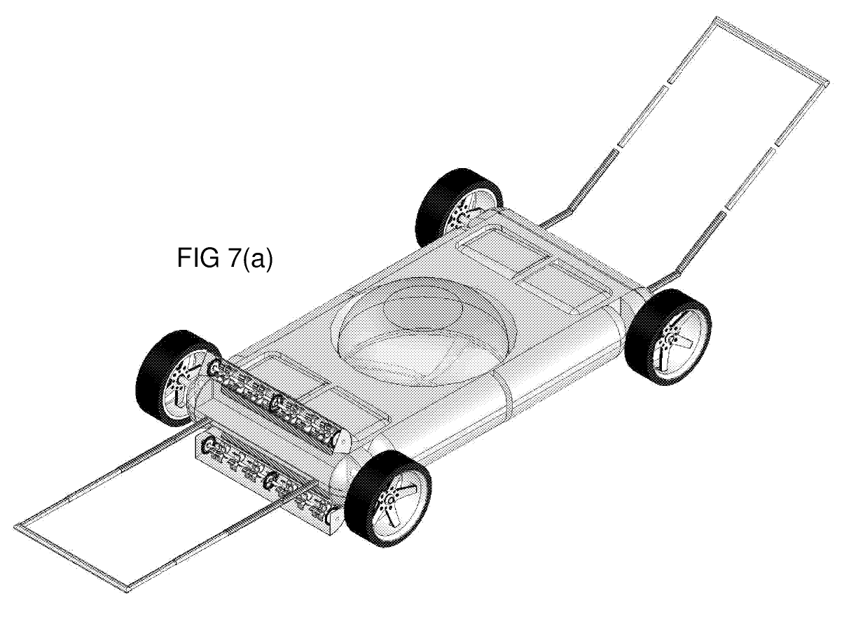

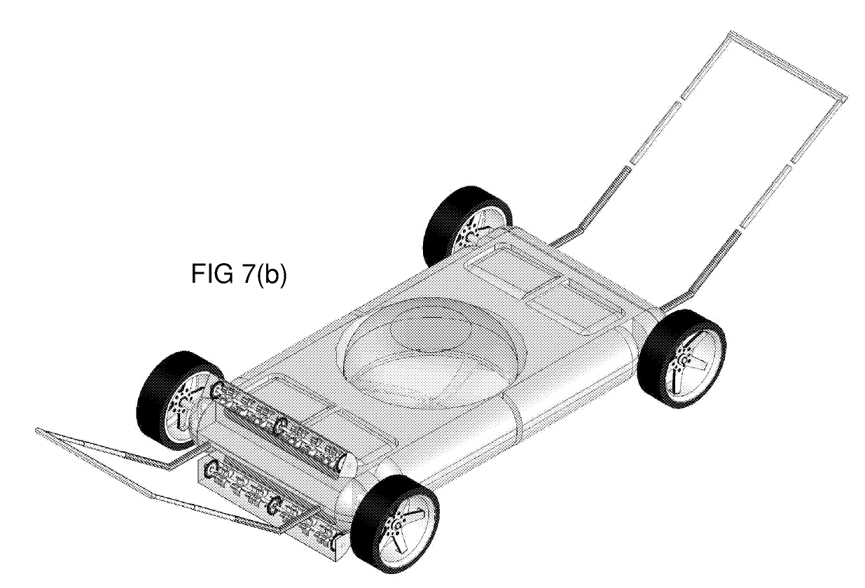

FIGS. 7(a) and 7(b) show BTSM moving its handles from extension to flexion in manual snow blower mode.

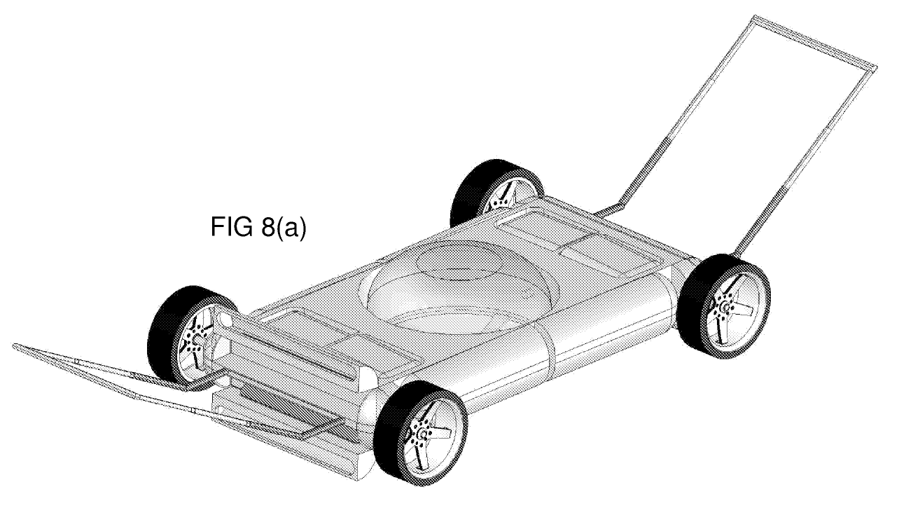

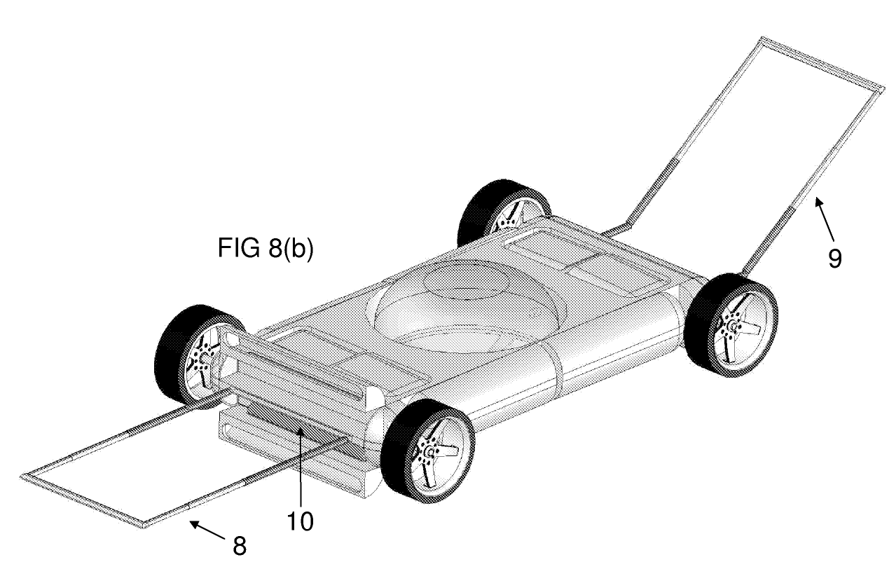

FIGS. 8(a) and 8(b) show BTSM moving its handles from flexion to extension in manual leave blower/vacuum mode; would describe labeled parts in FIG. 8(b) later.

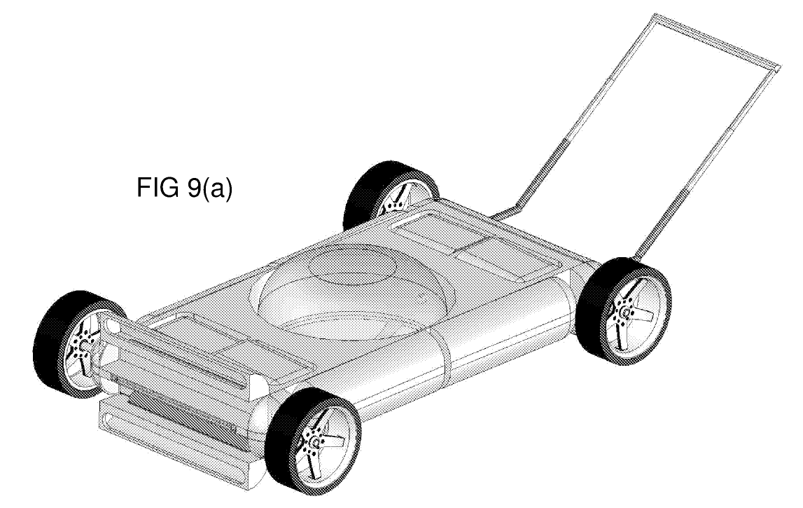

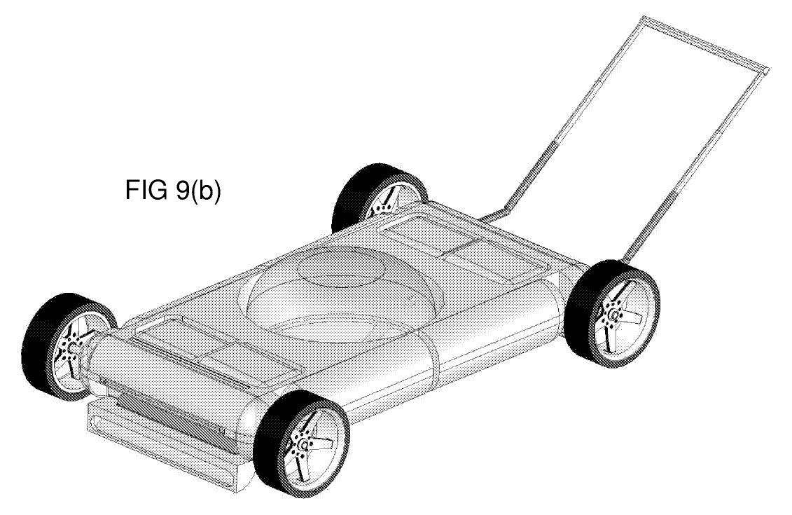

FIG. 9(a) depicts BTSM in manual leave blower/vacuum mode with top and bottom blower/vacuum engaged and ready for work.

FIG. 9(b) depicts BTSM in manual leave blower/vacuum mode with top blower/vacuum closed and bottom blower/vacuum engaged and ready for work.

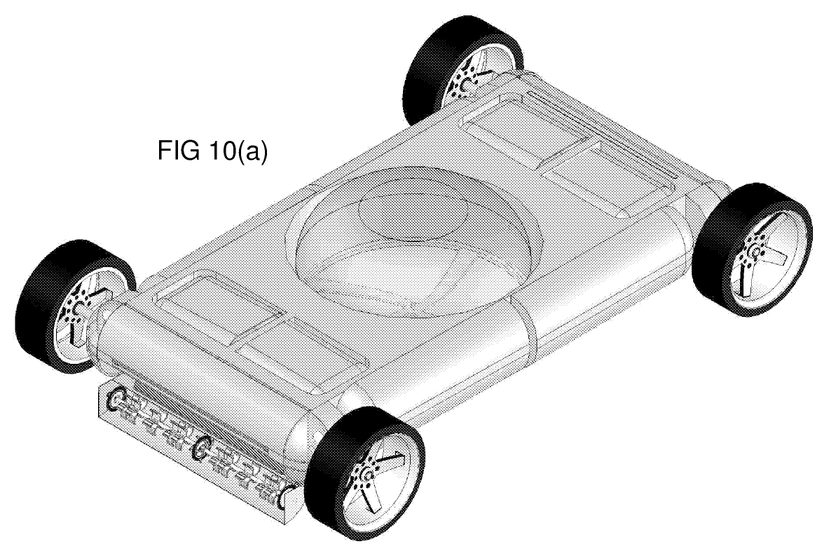

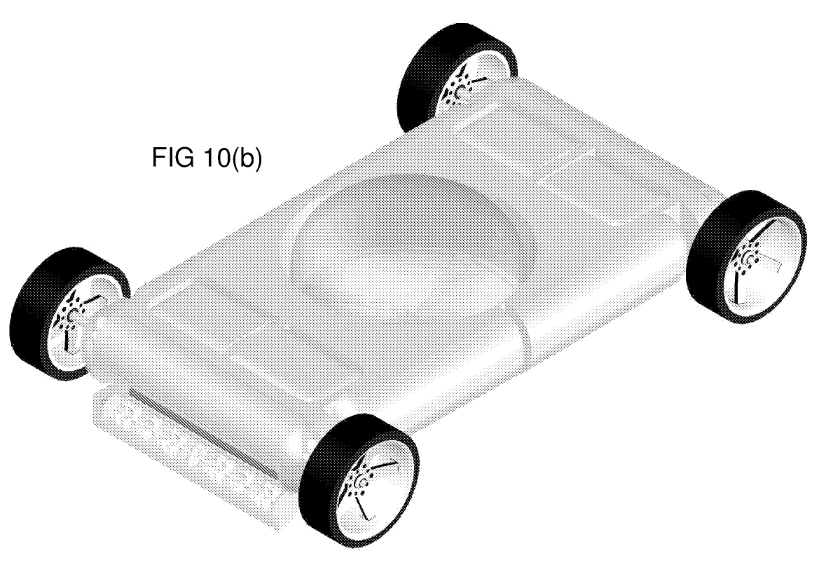

FIG. 10(a) depicts BTSM in automatic snow blower mode (BT snow blower mode or BTSB mode) with bottom snow blower running.

FIG. 10(b) depicts FIG. 10(a) in a fully shaded view which is what a real life model would look like.

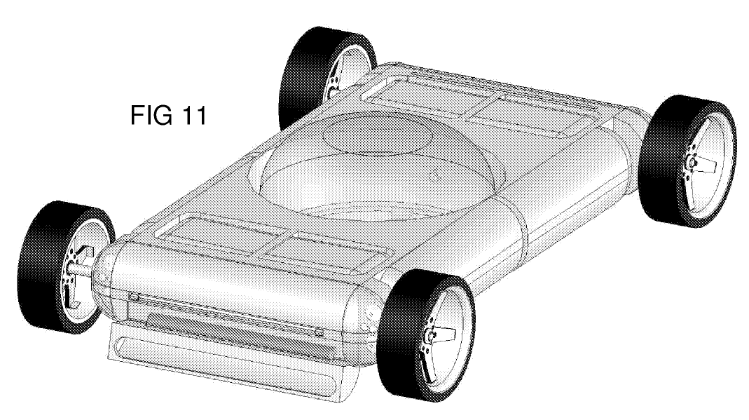

FIG. 11 depicts BTSM in trimetric automatic leave blower/vacuum mode (BT leaves blower/vacuum mode or BTLB/BTLV mode). Note that the vacuum generated is so powerful that BTSM doubles as a snow shovel in this mode. BTSM would suction the soft formed snow in and quickly evacuate it via any top 2 or bottom 2 of the high-powered 8-mini-actuator/blower/reservoir arms.

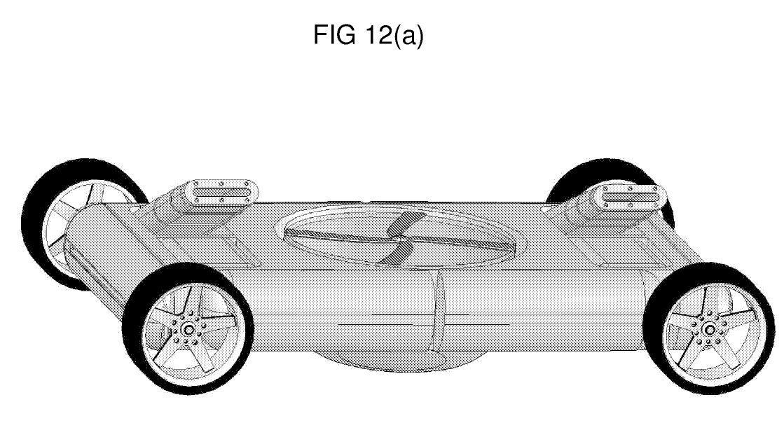

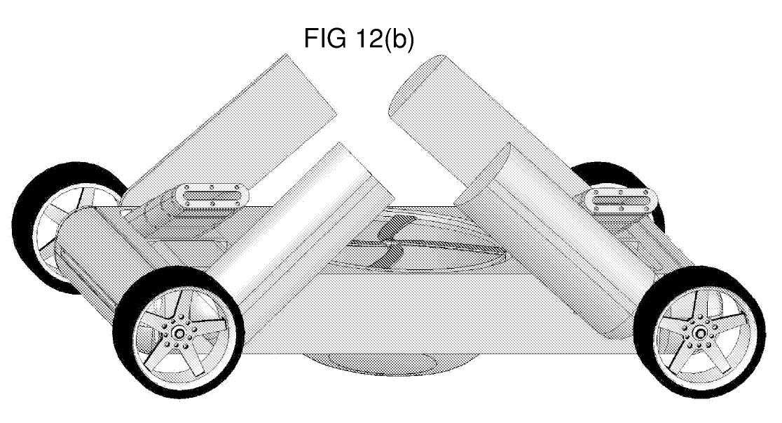

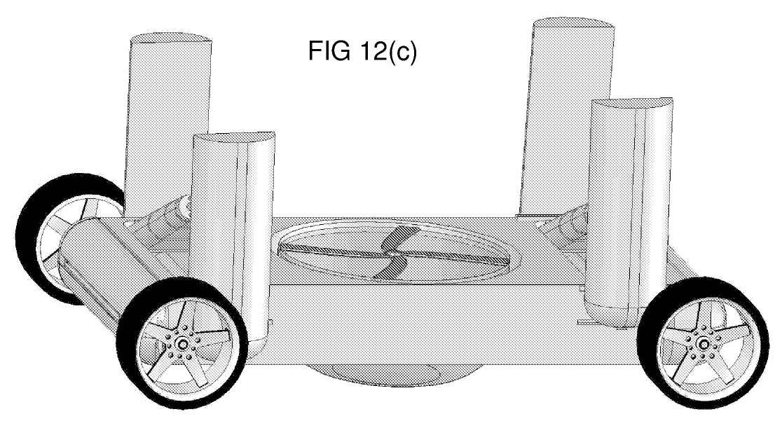

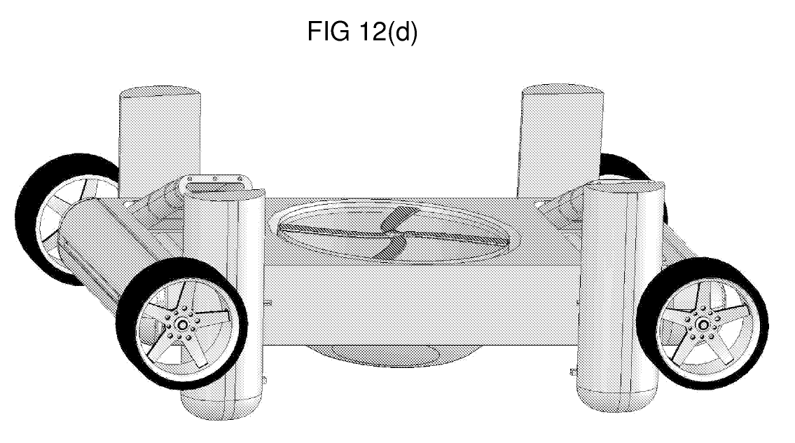

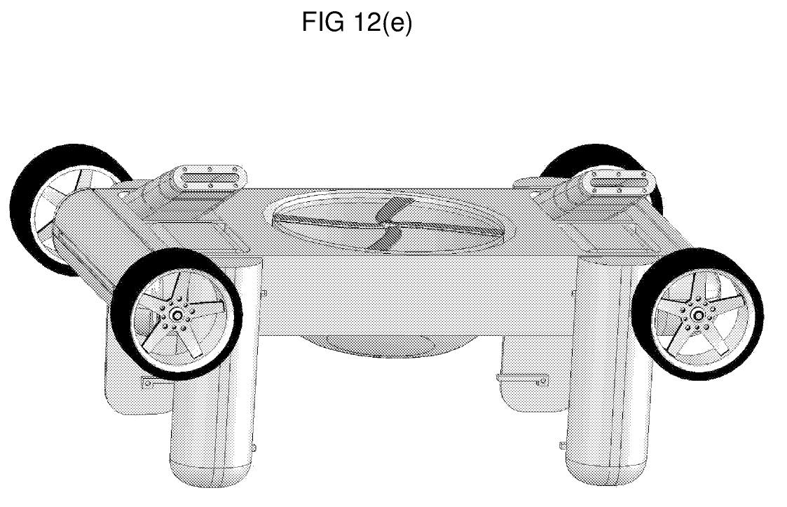

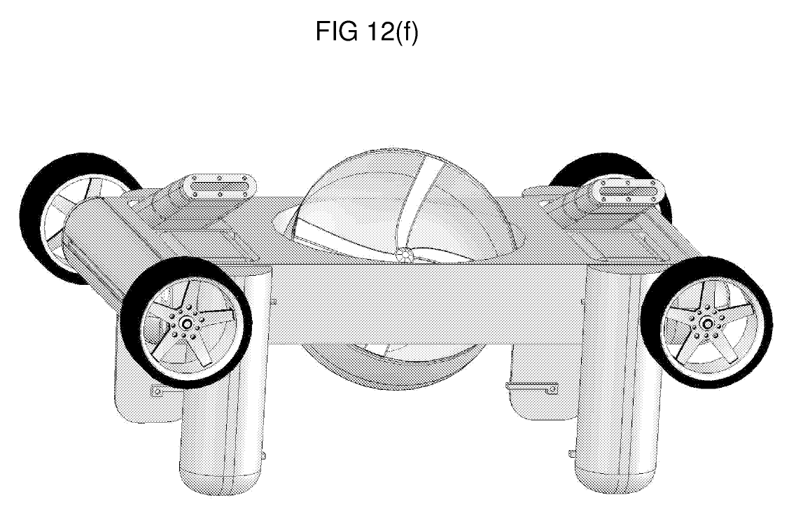

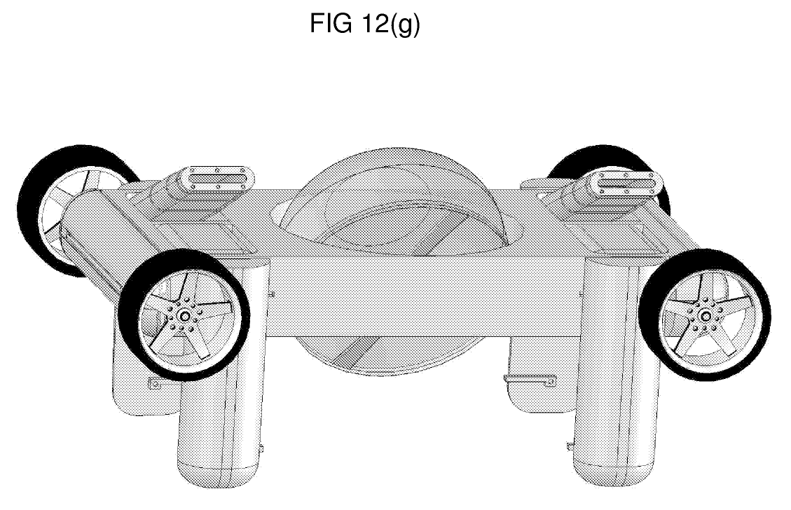

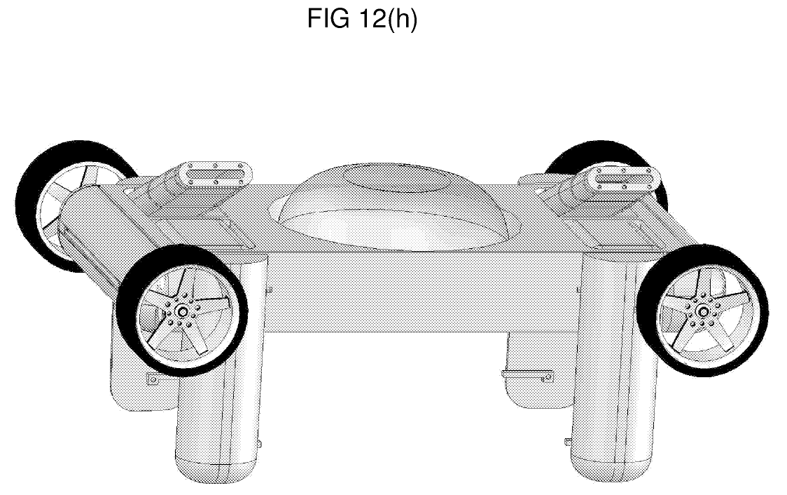

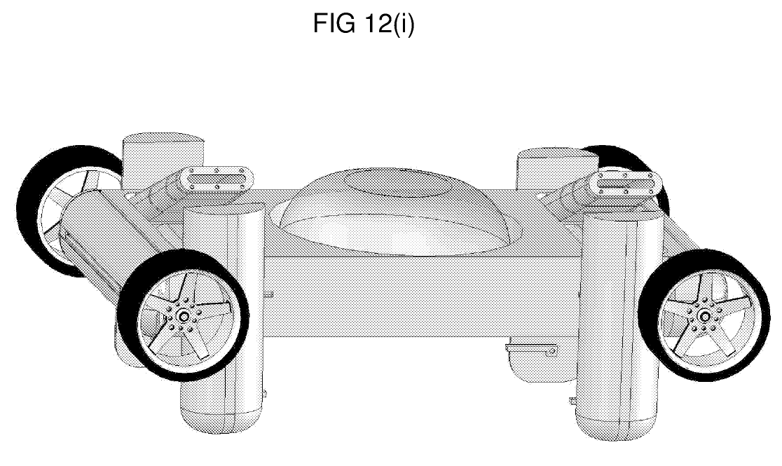

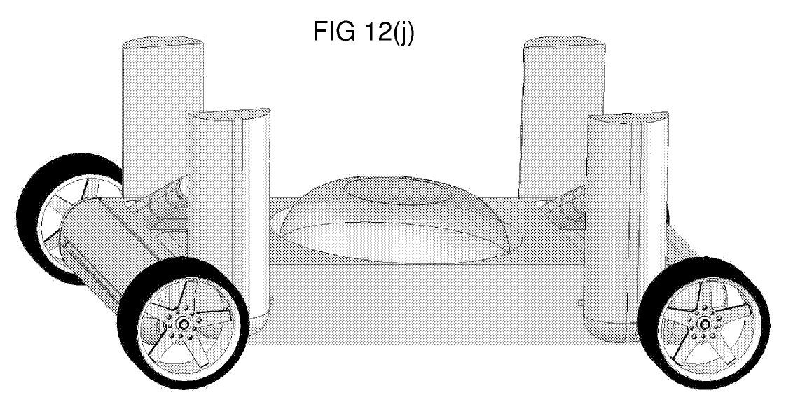

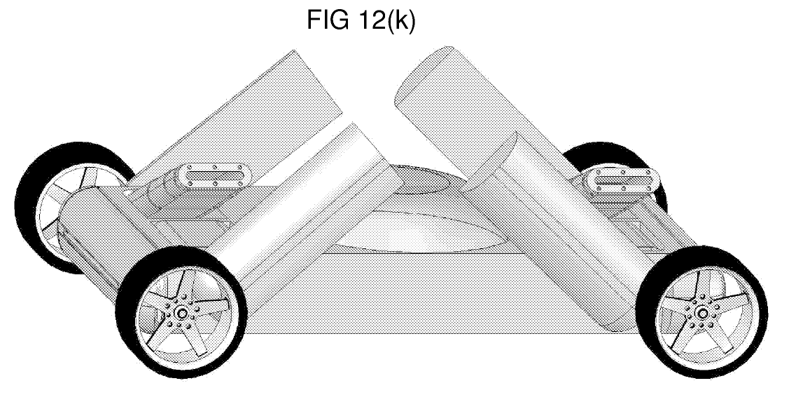

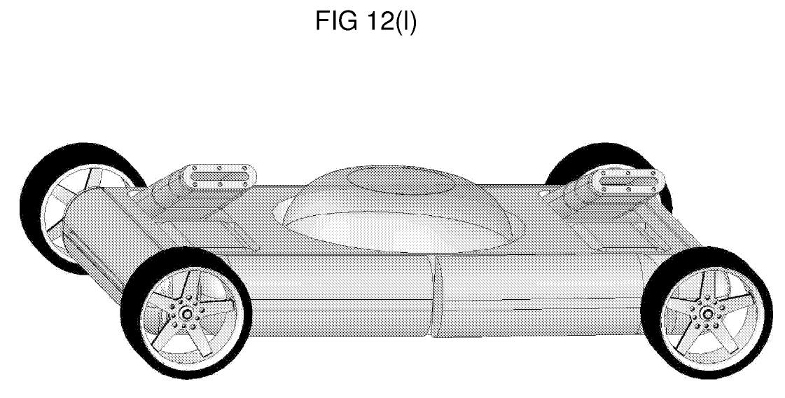

FIG. 12(a) through FIG. 12(l) depict BTSM in a frame by frame manner, exactly what happens incase it falls on its back when going over a steep or slippery slope in mower mode and how BTSM is smart enough to first of all locate flatter ground and then it goes through a series of actions to get back on its feet. Isn't that impressive? This one definitely puts BTSM a huge step ahead of other mowers out there. This feature helps make BTSM totally hands free so that you don't have to worry about it getting overturned in automatic mode.

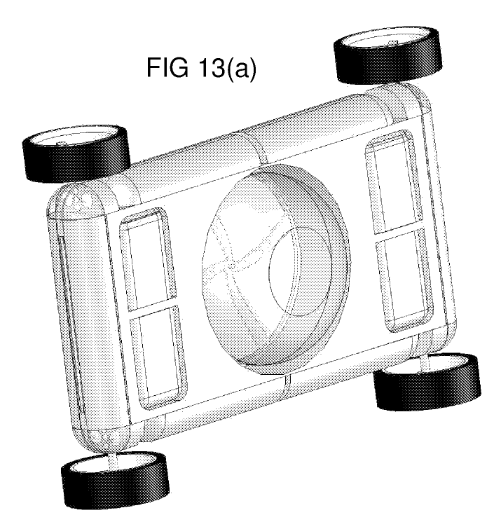

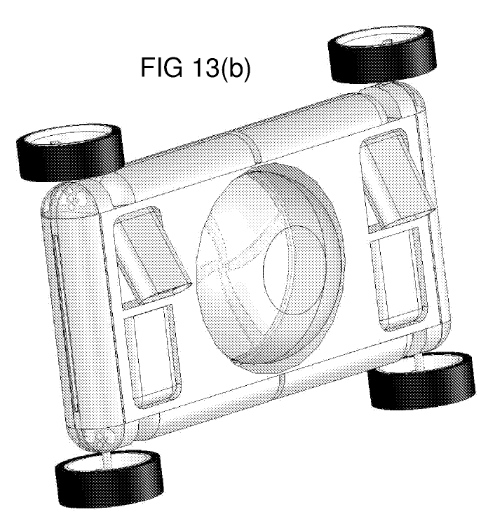

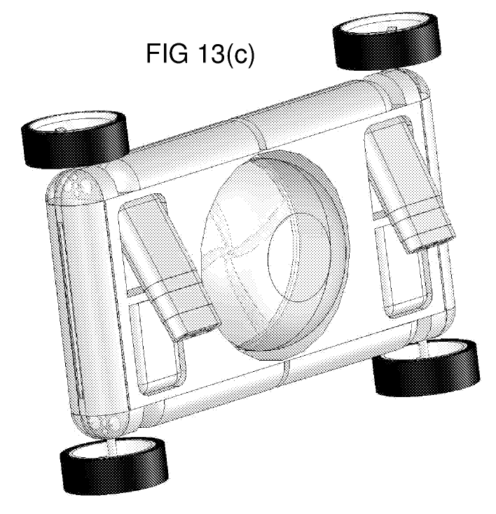

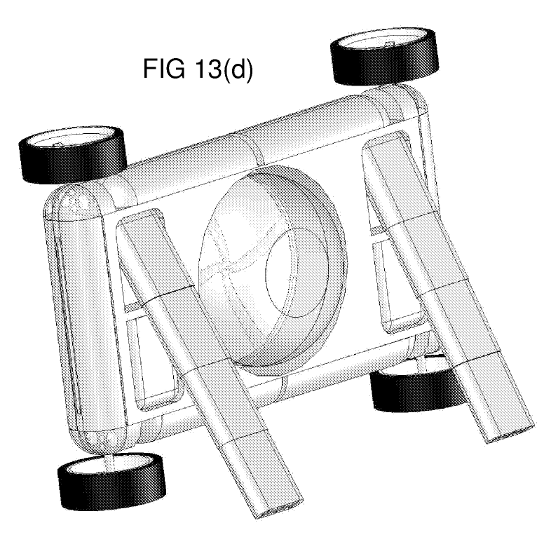

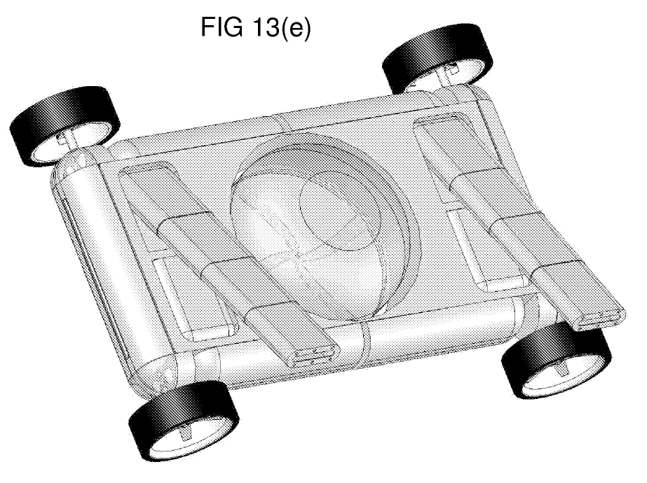

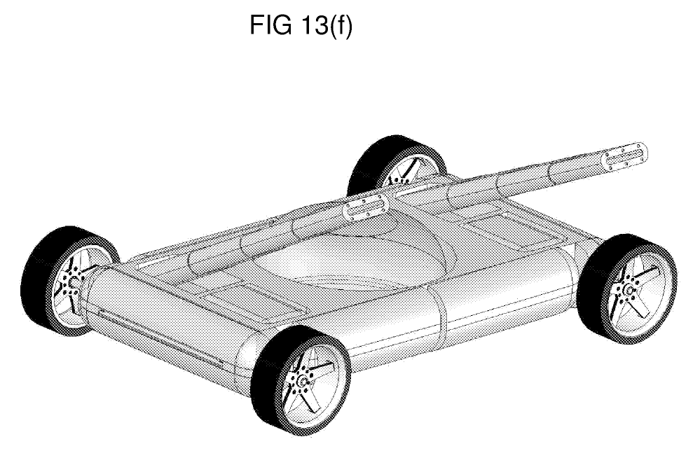

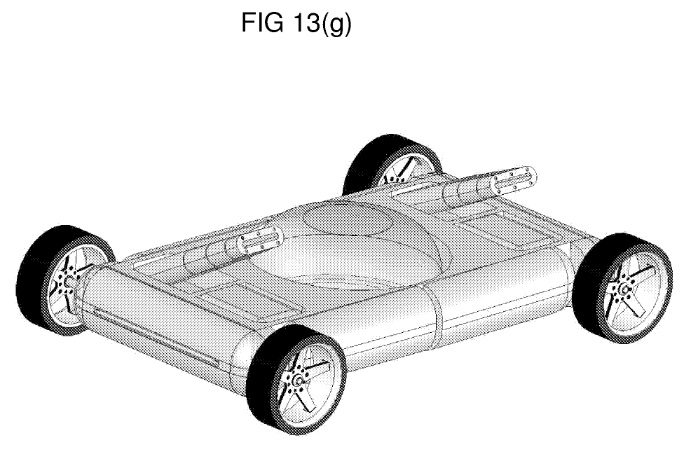

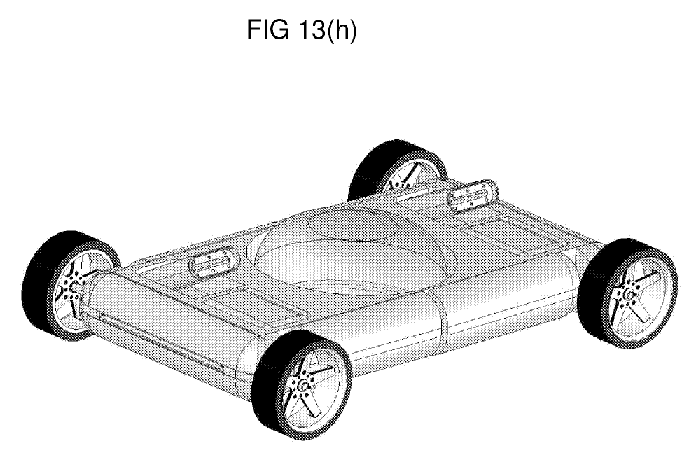

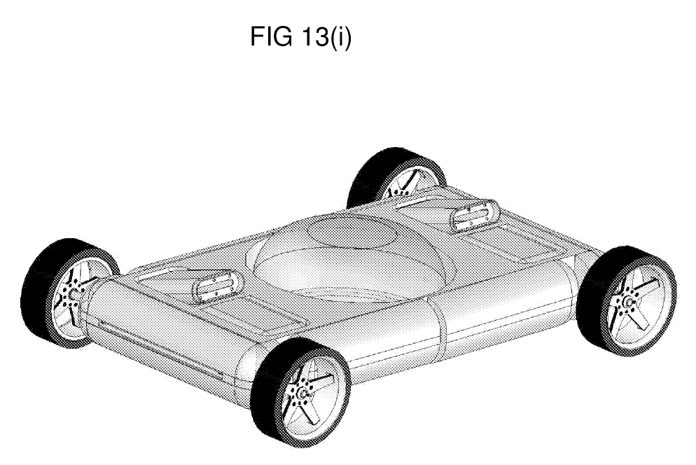

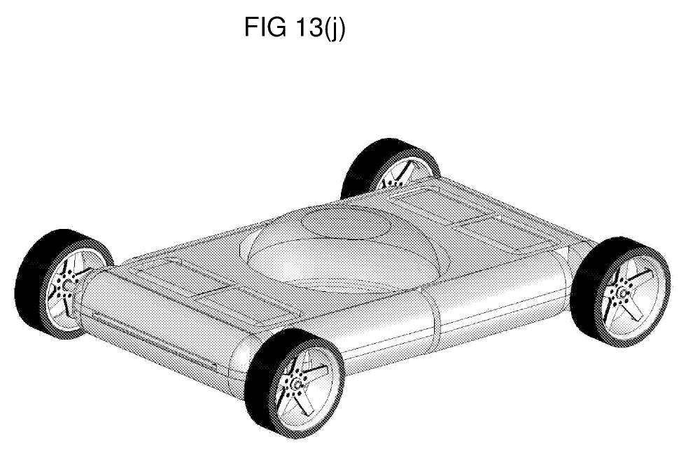

FIG. 13(a) through FIG. 13(j) depicts that BTSM (frame by frame) had managed to fall onto its side due to obstructions or a sloped hill. BTSM simply goes through a series of preprogrammed actions to get back on its feet. This is yet another unique feature to BTSM.

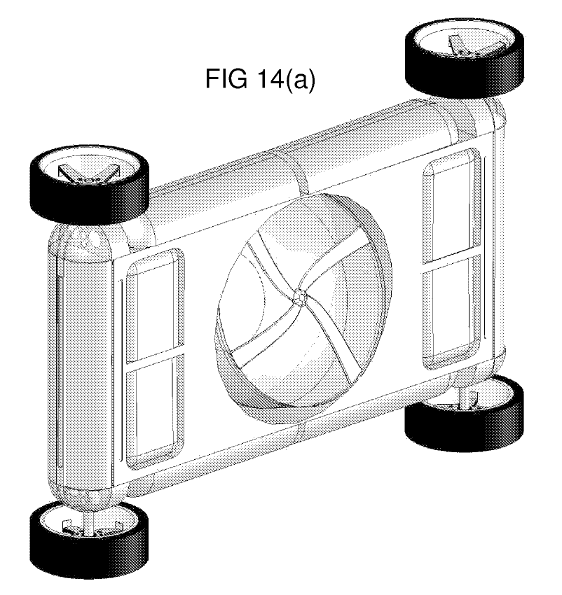

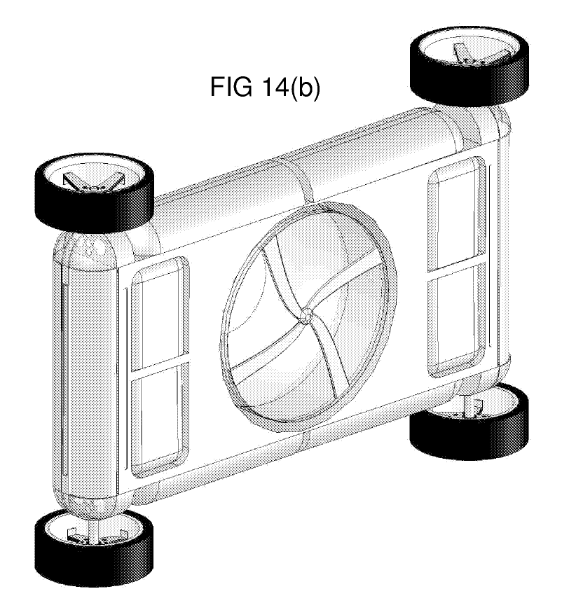

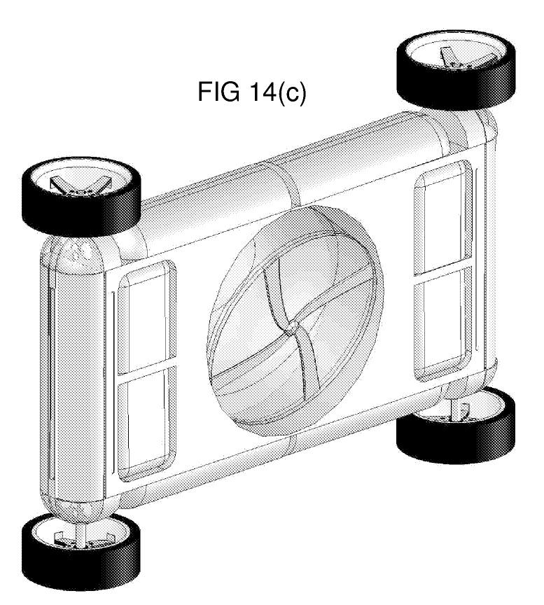

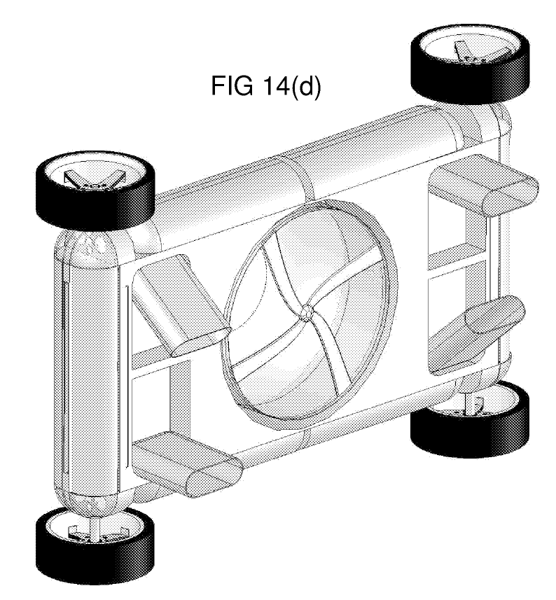

FIG. 14(a) through FIG. 14(d) depict BTSM (frame by frame) in one of its potential uses as described below in bells-and-whistles number 4. With specially attached turbine blades (not mower blades) BTSM becomes a makeshift high-power cooling fan. A special face cover preferably in one piece with the replacement blades would act as protectors just like a house fan to prevent potential injuries. Use it to dries that wet carpet, quickly ventilate a hot room or use it outdoors at a camp. Note that those arms in the pictures have both air intake and air outlet capabilities.

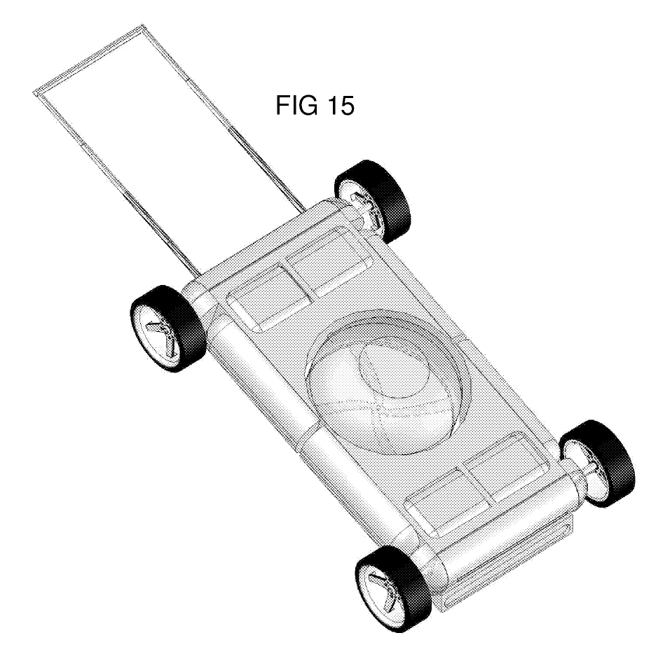

FIG. 15 depicts BTSM in manual vertical vacuum/blower mode. That's right BTSM can be run vertically or horizontally.

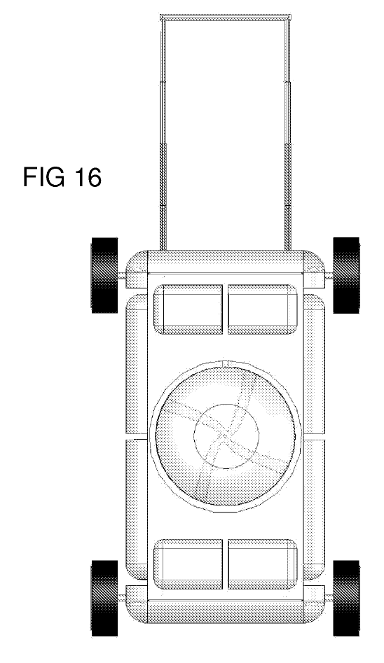

FIG. 16 depicts BTSM leaning against your garage wall for instance and ready to put its 1 to 4+ high power electronic air compressors to inflate a flat tire or simply to run your favorite high power air compression tools as discoursed below in bells and whistles 3. Isn't that wonderful?

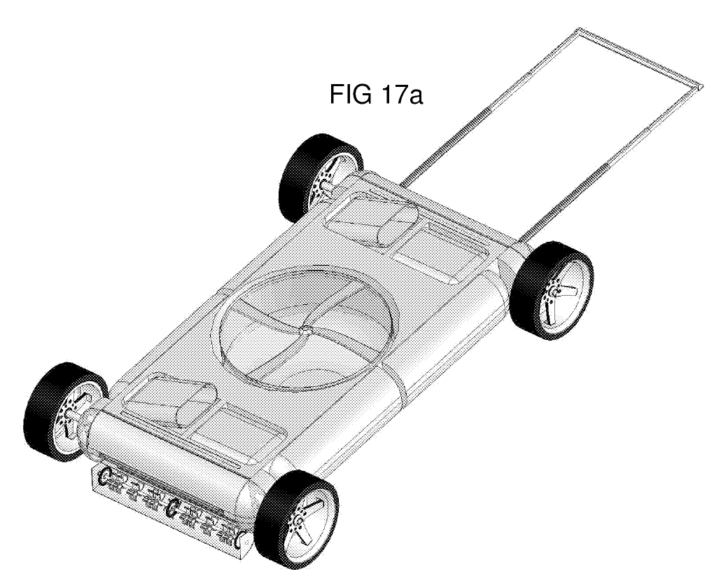

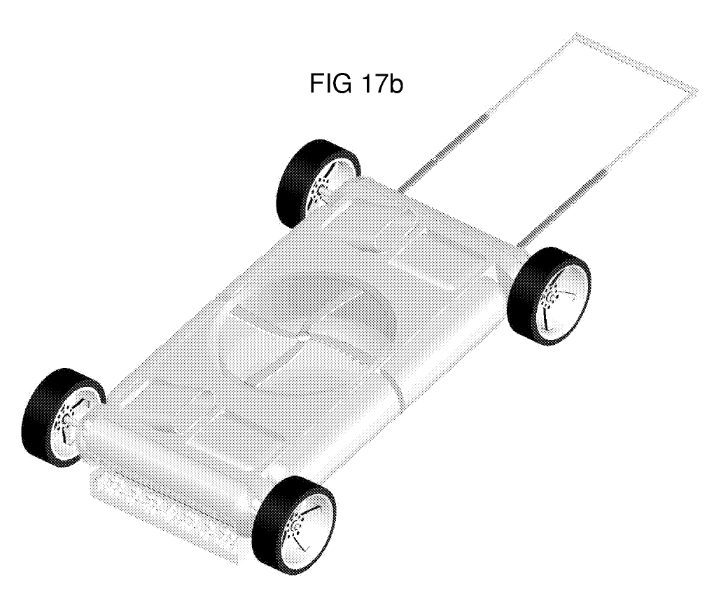

FIG. 17(a) depicts BTSM in manual vertical snow blower mode with high-power turbine mowing/mulching blades facing up and deactivated (blades can be faced down if preferred) with 2 of the robotic arm (labeled 11-18 refer to FIG. 2 and FIG. 3) exiting the snow with its high-power professional grade blower. Please note that the top blower can also be activated simultaneously to facilitate snow blowing depending on how much snow there is.

FIG. 17(b) depicts FIG. 17(a) in a fully shaded view which is what a real life model would look like.

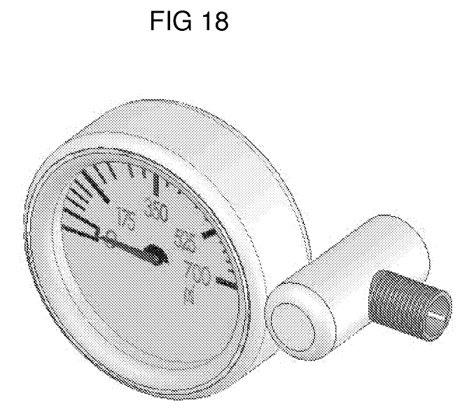

FIG. 18 depicts the heavy duty high-powered compressor gauge which is housed in the above said FIG. 2 label 33.

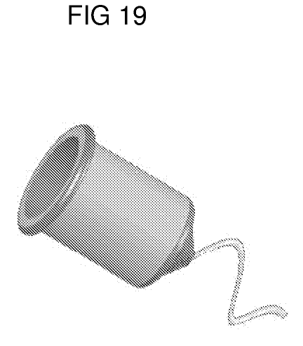

FIG. 19 depicts the retractable/anti-tangle female prong 12/24V DC outlet which is housed in the above said FIG. 2 label 32.

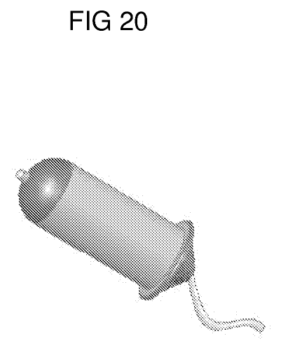

FIG. 20 depicts the retractable/anti-tangle male prong 12/24V DC outlet which is housed in the above said FIG. 2 label 32. Note that this male power plug can be used instead of the jumper cables to jump-start/charge your car battery by directly plugging it into the cigarette lighter outlet of your car which saves you the hassle of opening up your hood and getting your hands dirty. This plug retracts up to 12 feet so it would easily reach your vehicle's cigarette lighter. This method is especially great during winter season so that you don't have to stand out in the cold and rather sit in the car while your battery charges.

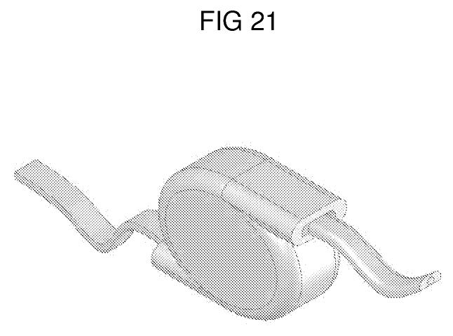

FIG. 21 depicts the retractable/anti-tangle heavy-duty-gauge automotive jumper cable unit which is housed in the above said FIG. 2 label 34.

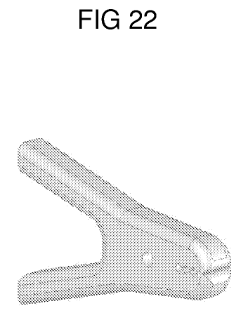

FIG. 22 depicts the jumper claw itself that would plug onto the positive and negative prongs of your automobile battery which is also housed in the above said FIG. 2 label 34.

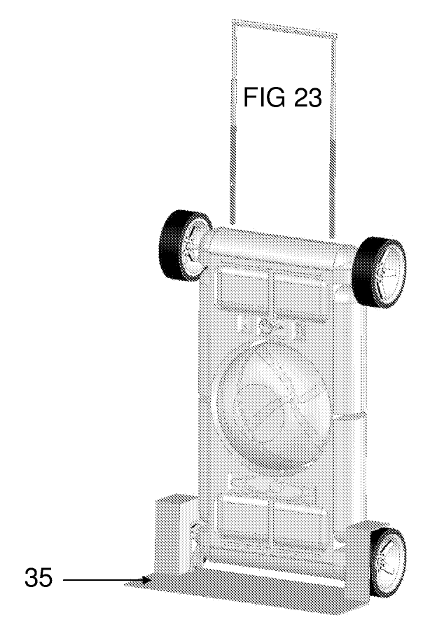

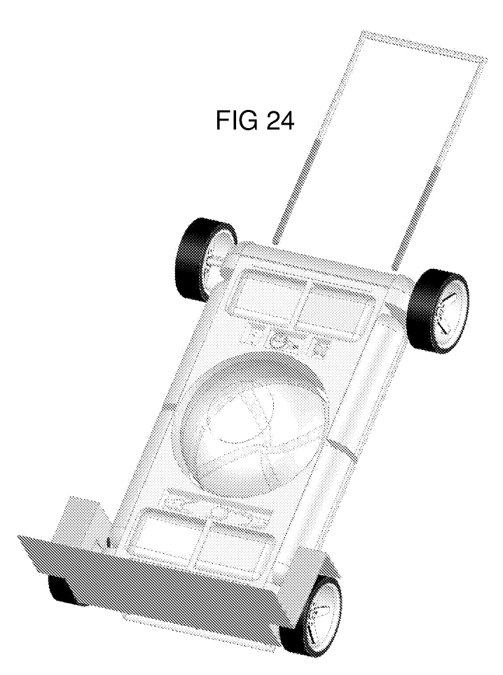

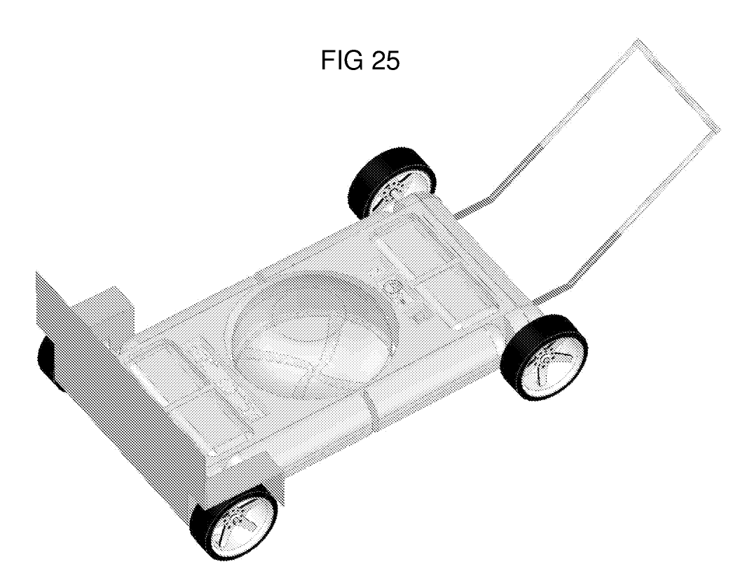

FIG. 23 depicts a special attachable device that instantly turns BTSM into a high-powered vertical (see FIG. 24) and horizontal trolley (see FIG. 25).

FIG. 24 depicts BTSM being wheeled along in vertical trolley mode.

FIG. 25 depicts BTSM being wheeled along in horizontal trolley mode. This mode allows for the hurling of more items at once.

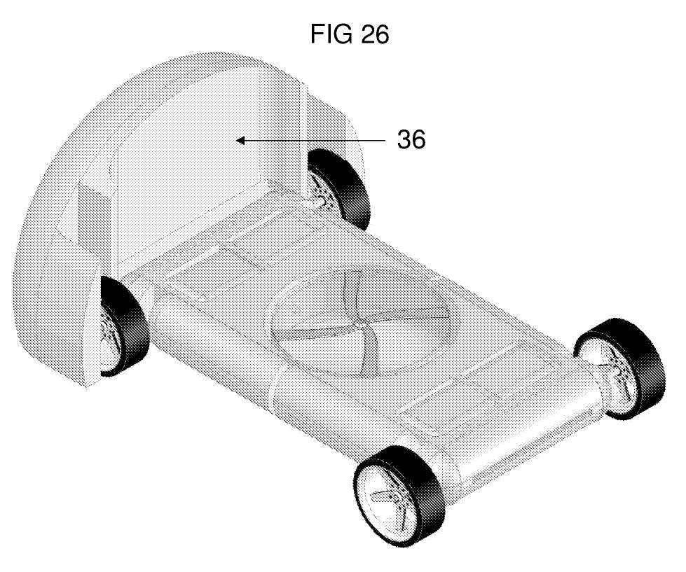

FIG. 26 depicts BTSM charging back at the base in horizontal charge-back mode.

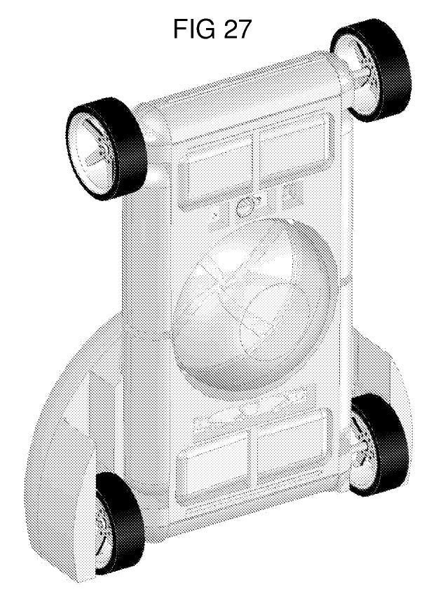

FIG. 27 depicts BTSM charging back in a space saving vertical charge-back mode after having auto-swiveled from horizontal mode. I would like to suggest this particular photo for inclusion on the front page of my patent application.

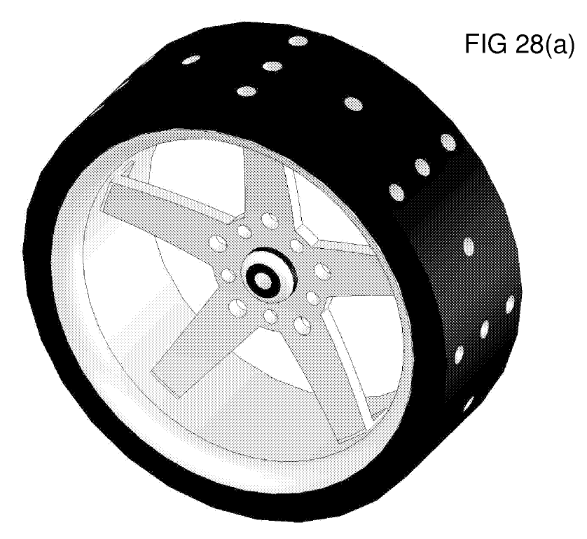

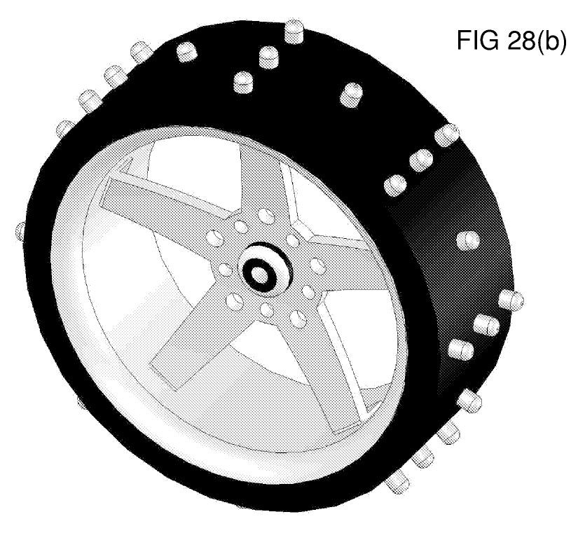

FIG. 28(a) and FIG. 28(b) depicts BT's concept of the next generation approach to tire treads and wheel traction without having to use a chain. This version shows single individually retractable treads.

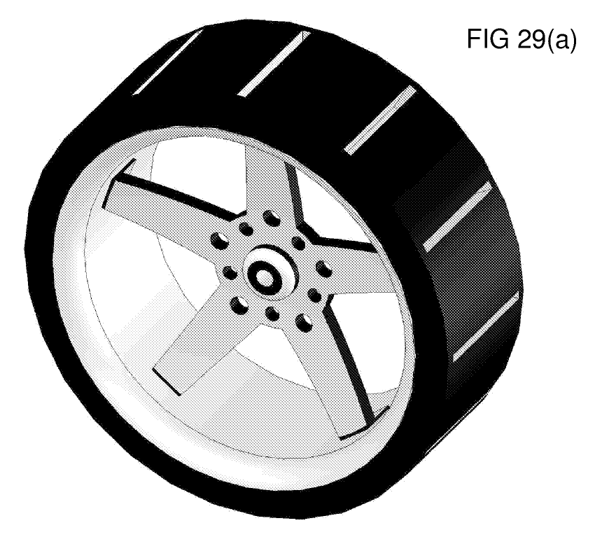

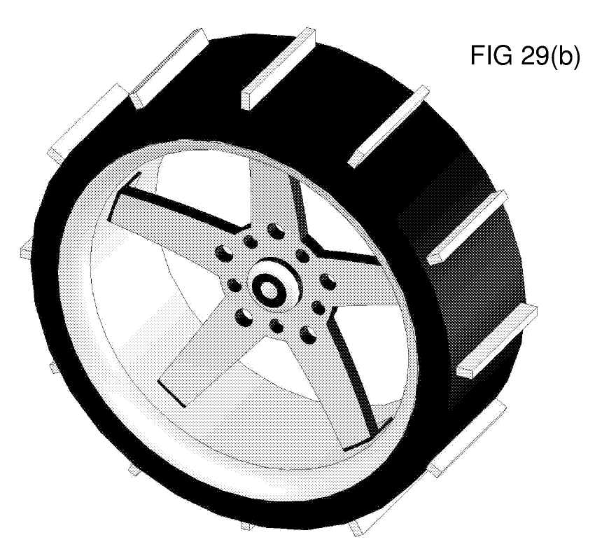

FIG. 29(a) and FIG. 29(b) depicts BT's alternate approach to the next generation tire treading and wheel traction without having to use a chain. This version shows the treads retracting linearly across as one single unit.

To further clarify FIGS. 2, 3, 8(b), 23, 26 and their part listings.

FIG. 2 label number 1 depicts the main chassis. Note that this chassis/platform can linearly actuate up or down vertically to make up for height. An example of this would be in an effort to avoid a tree stump or some other obstacle or simply in an effort to cut ever closer to the ground. In addition, this platform houses extra battery power and the solar system. As an alternate solar system housing, the top portion of the shield in FIG. 3 label 29 could utilized.

FIG. 2 labels 2 through 5 depict the reservoir for head lights, some sensors, some alarms and other waning devices such as the GPS/satellite systems for visibility, navigation purposes and incase of a theft.

FIG. 2 labels 6 and 19 depict BTSM' leave blower/vacuum and snow blower respectively.

FIG. 2 labels 11 through 14 depict 4 of 8 mini actuating arms that have a rotary motion and a linear motion. These arms help BTSM get off its side incase of a side-flip. These arms act as blower/vacuum reservoirs so as to suction or expel mulched grass (finely grinded grass), snow, and other debris from the center huge hole (see FIG. 4). They also double as a way to sprinkle grass treatment out of the 6 tinny circular holes (see FIG. 4).

FIG. 2 labels 21 through 24 depict the very important 4 side actuating arms that have the capability to make a rotary motion and a linear motion. These arms make BTSM anti-flip. They also double as potential housing for compressors (4 independent compressors) that may run individually or as a whole and running all four together is like running your car on 4 engines. You simply get an uninhibited professional grade high-power air compression at all times. Now, talk about turbo charging. BT laughs. Also 4 high-power rechargeable batteries may be housed here otherwise they may be housed in FIG. 2 label 1.

FIG. 2 label number 31 depicts 110/120 VAC power outlet housing to help power-up portable devices whether indoors or outdoors.

FIG. 2 label number 32 depicts retractable 12/24 VDC female and male prong power outlet housing to help power-up portable devices whether indoors or outdoors.

FIG. 2 label number 33 pictures the inbuilt high-powered compressor (up to 700 PSI) housing which can quickly inflate your car tires and run air compression tools.

FIG. 2 label number 34 pictures the inbuilt retractable heavy duty vehicle jumper/charger incase of a low or dead battery.

FIG. 3 labels 7 and 20 depict BTSM' leave blower/vacuum and snow blower respectively.

FIG. 3 labels 15 through 18 depict the remaining 4 of 8 mini actuating arms that are equipped with a rotary motion and a linear motion.

FIG. 3 labels 25 through 28 depict BT's next generation special traction tires. Note that these tires can actuate in and out linearly via the axels. When the tires actual closer to the chassis, BTSM can squeeze through a narrow pathway and when they pull further away from the chassis, BTSM can maintain more stability, balance and help facilitate efficient turns. Also, note that an important feature of BTSM is that it can virtually make a 360° turn on the spot. This is because the front and rear wheels turn opposite each other to help facilitate quicker and more efficient turns. For example, in order to make a left turn the front tires turn left and the rear tires slightly turn right to help facilitate a sharper and quicker left turn. In addition to that, BTSM' wheels can run independently of each other so that if 1 or more wheels are off the floor, BTSM can move the remaining wheels.

FIG. 3 label 29 depicts the protective shield/container that houses BTSM' turbine blades. Now this amazing shield has the ability to make a 360° rotation within its axis and also a linear motion. This linear up and down motion is what allows BTSM to cut that grass to a precise height and produce a flawless professional grade design at all times especially when designing checkers. Note that this up and down linear motion of the shield would be independent of the linear up and down motion of the chassis in FIG. 2 label number 1. The top part of this shield/container could also be utilized as an alternate housing for a solar energy unit.

FIG. 3 label 30 depicts the special four bladed turbine that would be made out of Kevlar/titanium material or the like to facilitate the mulching of grass to fine powder which is the key to BTSM not needing to hull around an unnecessary catch bag/reservoir. Be it dead or dried up leaves, weed or fresh wet grass, anything that is pulled into BTSM' powerful turbine vortex comes out as fine harmless powder that would provide nutrients and fertility to your lawn. Although a single quad turbine blade is pictured to save drawing time and complications the real BTSM may need several layers of high-powered blades in order to achieve fine powder as the end product.

FIG. 8(b) label 8 depicts the handles (equipped with an onboard mini-remote control) used when in snow blower manual mode (semi-automatic mode).

FIG. 8(b) label 9 depicts the handles (equipped with an onboard mini-remote control) used when in leave blower/vacuum manual mode (semi-automatic mode); note that BTSM also doubles as a general blower/vacuum in this mode.

FIG. 8(b) label 10 depicts 1 of 4 major pipelines that help to channel debris out via any of the 8 actuators and/or reservoirs. FIG. 2 labels 6 and 19 would have pipelines as depicted in FIG. 8(b) label 10 respectively. FIG. 3 labels 7 and 20 would also have pipelines as depicted in FIG. 8(b) label 10 respectively.

FIG. 23 label number 35 depicts BTSM with the special attachable device that instantly turns it into a high-power classy looking vertical/horizontal trolley. The attachable device is designed to cover/protect the wheel as you move along. Also, this device (front to back) is 2 to 2.5 times longer than the conventional ones which facilitate the lifting of wider base items. If you take a closer look at the picture you would find that the base of the said device where the arrow specifically points at slopes down to an almost paper-thing edge which is further beveled to facilitate easy lifting/picking up of boxes. The said device also has the capability to swivel and lock into position to help keep BTSM standing straight without falling over when parked in vertical mode. Another extra feature of this device is that it has a broader width (side to side) which extends right in front of the wheels to allow for an even larger item pickup.

FIG. 26 label number 36 depicts the special rechargeable base that has the capability to charge BTSM in horizontal mode and vertical mode/space saver mode (see FIG. 27). The way this works is that BTSM automatically navigates to the base and initially plugs into the base in horizontal mode. BTSM then pivots/rotates at a perfect 90 degree angle to vertical position in order to save space. You have the option to select a horizontal or vertical charge-back position.

### DETAILED DESCRIPTION OF BTSM

### Marking and Tracking the Fields

BTSM is a friendly little robot that can help facilitate lawn mowing all year round, leave blowing during the fall season and finally snow blowing during the winter season. That's right, BTSM is not just a mower, but also a leave blower/vacuum during fall, a snow blower during winter, and with a few other functions in the bells and whistles section below you can think of BTSM as multi-purpose all-in-one machinery that gets the job done. Below is a description of how BTSM would navigate your lawn in automatic mode. Note that these same marking and tracking techniques apply to your driveway, porch and or garage areas. Basically, the simple idea is as follows.

There would be electronic laser precision devices I call markers that would be put around the border of a lawn/driveway a few feet from each other in order to create a virtual 3D map of the lawn which would then be communicated to BTSM' computer or base. These markers are basically an invisible guide that lets BTSM know its boundaries and limitations so that it doesn't stray off to the streets or better yet, run off and start mowing or leave blowing your neighbor's lawn (BT laughs). These markers would be placed all around the edges of your lawn/driveway which would indicate where BTSM is allowed to touch and also act as a guide so that BTSM can find its way from the resting spot (garage or porch) out to the fields. Once this step is completed you no longer need to place the markers because BTSM has stored and can recall the boundaries or the perimeter of your compound and if anything dramatically changes, you can always update BTSM. Now that BTSM knows where to cut, it can either randomly decide on where to start cutting or you may pick a place or sight for BTSM to start cutting from (initial cutting position). You may decide to keep the initial cutting position you pick as default or you may also change this any time as needed.

BTSM is to be rigged up with a special remote control system that can directly be synchronized to your garage door and or other doors so that it can automatically open and close the door when leaving for a cut or reentering from a cut and simply park it self at the base for recharging.

After you have marked and tracked the lawn, BTSM would then do what I call an ‘initial screening’ of the lawn. This is when BTSM first drives over the lawn in order to learn about the overall condition of the land while it stores 3D information about high and low spots which would help determine just how much speed and or traction is needed in order to fulfill a professional cut at all times. During this first dry run, BTSM would use inbuilt precision guided lasers and or rollers to mark the ground into a virtual 3D map and store it in its system. These lasers/rollers are not to be confused with the precision markers that are placed on the borders of the lawn. They simply tell BTSM how high or low it should raise its blades when cutting in case of tree stumps and other unforeseen obstructions. The laser devices would be spread all around BTSM (top, bottom, front and back) since BTSM is capable of running upside down, right side up, forwards and backwards seamlessly as depicted in the attached photos.

The forwards and backwards precision lasers help to guide BTSM against potential collisions and can smartly guide BTSM around potential obstructions that weren't there during the initial mapping phase via the border markers.

The upwards and downwards precision lasers constantly inform BTSM on how high or low the ground is since this may have changed since the initial mapping phase via the border markers. This is an added protection that helps prevent potential blade and ground collisions.

BTSM would be rigged up with fluorescent icy-blue/white led lights so that it can be seen incase its dark outside. BTSM would also be rigged up with alarms that would sound incase of a theft and other warning beeping sounds that would indicate it is running and functioning. FIG. 2 labels 2 through 5 depict the housing for the lights, some of the sensors and some of the alarms. Please refer to FIG. 1 front view for a better look.

Also, BTSM would have a remote control in which one can use to remotely (while away from the actual physical location) monitor it or simply control it as needed (as though it were a classy remote control toy). This remote control feature is further described in the bells and whistles sections below.

### Technicalities and Functionalities of BTSM

First of all, I want to stress that BTSM would be made up of some of the toughest but yet light-weight materials out there. I suggest that the main body/chassis be made up of fiberglass or the like and that tough but reliable plastic should be used whenever necessary to help keep BTSM light-weight and portable. My goal is that BTSM should not be more than 40 to 50 pounds total if possible so that even a retired 90 year old female veteran can easily maneuver it in manual mode.

The CAD drawing of BTSM is of portable/miniature size at about 50% to 62.5% of a life size model which is 30″×16″×4″ with the tires being approx 6.09″. A medium life size model would be 48″×25.6″×6.4″ with tires being approximately 9.74″. A large life size model would be 60″×32″×8″ with tires being approximately 12.1″ or larger.

Please note that I could have designed FIG. 2 labels 6/19 and FIG. 3 labels 7/20 to open as one piece pivoting at about 180° angle. This would probably have been more effective especially in snow-blower mode but would have required a repositioning of the retractable handles elsewhere. I only designed them half-and-half at a 90° angle to help facilitate storage of the retractable handles in FIG. 8(b) labels 8 and 9. However, FIG. 2 labels 6/19 and FIG. 3 labels 7/20 can run simultaneously as depicted in FIGS. 7(a)/9(a).

BTSM (Wheels and Traction) FIG. 28(a) to FIG. 29(b):

To aid in traction, I have come up with an ingenuous wheel design that compare to that of an armored tanks or chains for your tires. My tires are designed with threads or ridges if you will that are capable of retracting in and out (what I call the porcupine effect). Isn't this great? These threads would slightly retract in and out to produce more grip and traction as needed. This would be very useful in the event that BTSM has to climb up a hill or slippery slop or even run during the winter either as an automated or manual snow blower. In snow blower mode, I suggest that the blades face up while the vacuum/blower/crusher does the work in order to prevent the blades from sustaining damage from frozen ice as depicted in FIG. 17(a) and FIG. 17(b).

I think that this idea of retractable threads is so great that it deserves a patent of its own. Imagine for instance having a specialized tire for your vehicle that has programmable/retractable threads which would prolong the life of your tires. As the threads wear, new threads retract out. This is specifically illustrated in FIGS. 29(a) and 29(b).

BTSM (Anti-Sideways Flip):

As illustrated in the attached drawings, FIG. 13(a) through FIG. 13(j) depicts BTSM (frame by frame) when it flips on its side. If BTSM flips onto its side, two of the four platform actuator arms would extend out at an angle pushing against the floor hence ushering BTSM back on its feet again. BTSM knows to rotate the quad turbine blades in opposite direction with respect to the actuators so that the blades face the ground once it is back on its feet. In order to facilitate this process, I would like to introduce a fluid balancing device or the like. This fluid balancing device would help shift BTSM' weight appropriately to help it back on its feet. For example, while BTSM is on its side, the weight shifts to the top while two actuator arms push again the floor at an angle to help get it back on its feet.

BTSM (Anti-Upside-Down Flip):

So BTSM managed to somehow flip upside-down? Not to worry because there are several ways to get BTSM back on its feet again. However, I came up with a rather simple and full-proof method as illustrated frame by frame in FIG. 12(a) through FIG. 12(l). If BTSM flips over for some reason, the blades automatically stop spinning, the four side arms then rotate outward till they are perfectly vertical, then they linearly extend down to lift the entire body off the ground. Once there is enough room such that the shield that holds the blade would not hit the ground, the shield would pivot/rotate a full 180 degrees to face the ground and once this is done, the four arms would linearly actuate up to let BTSM down and then rotate back into place. Once again, the blades start running and BTSM continues cutting from where it left off. Incase BTSM was sitting on an uneven ground (non-flat ground) it knows to find flatter ground before attempting the pivot/rotation. Cool huh?

BTSM (Programmable Feature):

With BTSM' amazing pre-programmed/programmable features, it can literally cut custom designs on your lawn. Designs range from a simple one-directional cutting to zigzags, curves, circles and even checkers. With BTSM' user friendly digital remote control with display, you could literally program it to cut your favorite design (golf course style, football field style, soccer field style, mixed style) or simply alternate or randomize to a different customized design every time. This feature is so customizable that you could even upload text designs from your computer to BTSM and have it write something like “happy holidays” on your lawn or something. That's right, with BTSM you would be the envy of your neighbors.

A typical program would look something like the following:
Code 1=lawn, code 2=drive way, code 3=front door, back door and porch, code 4=spray weed killer/grass treatment. So during fall season you might want to say something like code 1+code 2+code 3 since leaves can be scattered all over. During summer and spring you might want to say something like code 1+code 4 which means that BTSM would cut the grass and spray weed killer/grass treatment. During the winter you might want to say code 2+code 3 which means that BTSM should clear the drive way, the door way and the porch of all snow. Cool huh?

### Bells and Whistles

Firstly, as an added option, BTSM is rigged up with a pen sized rearview and forward view day/night fully digitalized cameras (housed in FIG. 2 labels 2, 3, 4 and 5) so that one can remotely monitor its where about and progress via a remote control. Say for example you are out on a vacation. Well no problem because you could easily tune in via the computer or your cell phone to check on BTSM and with the help of GPS, you could even monitor things like the exact location of BTSM, important maintenance data from BTSM' main computer, and better yet with the help of satellites and the internet, you could get a sneak pick of the parameters of your house via the rear/front view camera on BTSM to further assure you that everything is ok. So there you have it, BTSM also doubles as a way to monitor your home if you will while you are home away from home; now isn't that wonderful?

2ndly, the remote control would have a clear digital LCD screen that would monitor and communicate to and from BTSM (and its main board/base) and also to and from the GPS and satellite systems. This is an added feature against theft. Incase of theft, BTSM sounds its warning systems. BTSM knows to activate its alarm systems if it ever strays off a preset parameter around your compound which would probably indicate a theft. Firstly, BTSM sounds a loud and distinguishable alarm almost similar to a car alarm in order to deter a thief, but if that fails no worries because BTSM is constantly being tracked by its main computer, GPS, and satellites so all data about its location is uploaded to the main base computer hidden in your home. This information would then be made available online, via cell phone (you may set it up such that automated calls to your cell informs you or you may also call in to monitor BTSM status), or better yet this information may be made available to law enforcement officials so that by the time you even find out BTSM is lost/stolen, the cops would probably already be booking the suspect. This is just my way of protecting a one of a kind investment and ingenuity such as BTSM (virtually theft proof).

3rdly, BTSM is not only a blower/mower/vacuum (BMV capabilities), but also doubles as an instant high-power portable electrical compressor which would be very handy in inflating tires, running air compression tools, and blowing dust and debris off floors and furniture. Refer to FIG. 2 label 33 which shows the compressor housing and also FIG. 18 which shows the compressor gauge by itself. So your tire is flat? Not a big deal, just wheel out your BTSM and inflate with the included anti-tangle retractable air hose. So you need superior air power for your air tools? No big deal, just whip out BTSM and you have all the instant air you need to run your power tools. To clarify things, a single high-power compressor is housed in FIG. 2 label 33, but up to four compressors that would work simultaneously can also be housed in FIG. 2 labels 21 through 24 to generate more power.

4thly, with a special attachment fan/turbine included (not the quick-detach mowing turbine blades); BTSM turns into a high-power top of the line heavy duty fan/turbine. Use it to quickly dry up that wet carpet, use it as a high-end make shift fan to cool or ventilate a hot room during summer, or use it while outdoors camping. Isn't that wonderful? FIG. 14(a) through FIG. 14(d) depicts BTSM in turbine fan mode (note that the shield has a swivel-open vent on top of it to allow air to flow through it). To further finish up this option, there is an added safety device that would cover the special attachment fan/turbine preferably as a single piece in order to prevent potential injury from open blades (just like your home standing fan has protective cover).

A 5^{th} thing that BTSM can do is to sprinkle weed killer/grass growth solution to help maintain a healthy lush looking lawn so that you don't have to go and spread/spray weed killer or grass treatment yourself. The best way to do this is via two bottom actuating arms that are perpendicular to one another because that would cover the entire area beneath as BTSM moves forward or backwards. However, FIGS. 1, 4, 12(a), 12(l), 13(f), and 13(g) show parallel/side-by-side actuator arms distributing weed killer/grass growth solutions. Note that as an alternate solution, the weed killing/grass growth solutions may be easily spread off of a reservoir that would be housed in FIG. 2 label 1 rather than using the actuator arms.

The 6^{th} thing I would like to add is the fact that BTSM also doubles as not just one, but two types of trolleys. That is a vertically lifting trolley and a horizontally lifting trolley. This is great because with all the power and remote options available with BTSM, you are basically running a high-powered electronic trolley so safe your elbow grease and allow BTSM to do all the pulling and tugging for you. If you look at FIGS. 23, and 24 you can see that a special attachment device is fitted to BTSM around the wheel-base so that you can lift and transport things like boxes around the house (vertical lift mode). FIG. 25 depicts BTSM in a horizontal lift mode which allows you to hurl even bigger items. Remember that FIG. 3 label 29 can linearly actuate within the chassis such that it is flush which would be helpful in creating a flat surface while in trolley mode. Check out this scenario. You need to move logs inside for your fire place so you set BTSM in horizontal trolley mode, load it up with fine lugs and BTSM automatically navigates itself from your backyard to the drop-off site where it is off-loaded and then navigates itself back to the backyard for another load. To BTSM from losing the load, special belts/bands help hold the load in place.

A 7^{th} and very important option of BTSM is that it also acts as a high-powered electrical charger even while in idle mode. BTSM is equipped with enough raw power to jump start your vehicle with the included retractable anti-tangle jumper cables as depicted in FIG. 2 label 34 and also FIGS. 21 and 22.

The 8^{th} thing is that BTSM is also equipped with appropriate outlets to power other mini electrical tools and devices either in VAC or VDC as depicted in FIG. 2 labels 31 and 32 respectively. For example, you are out camping and you need to charge your cell phone or power-up other portable devices.

Last but not the least; after all that BTSM can do we have to remember that it is basically a wonderfully unique machine (a rich-man child's play thing if you will. BT laughs) so you may buy it for all its yard work functionalities, potential indoor and DIY functionalities, bells and whistles, or simply as a rather classy and cool looking robot with all its actuating arms and legs and all.

### BTSM (Sources of Energy)

I prefer for BTSM to run off of electric power or the like so that it is virtually hands free, environmentally friendly, and maintenance free. Note that BTSM also simultaneously runs off of solar energy which helps to save and replenish battery power.

BTSM has a rechargeable base and also an independent electrical cord which can directly plug into an outlet which could be used instead of the rechargeable base.

### The Feasibility of BTSM

As you can see, I (BT) have put in a lot of time, hard work, and dedication to show that BTSM, a one of a kind innovative idea is very feasible as I have illustrated with the attached 3D CAD drawings. The only thing now left to do is for my fellow engineers (manufacturers) to actually make a BTSM, give it some power, some brains, and then put it to work. I mean, BTSM is not just another flimsy little robot, but rather it is a unique piece of ingenuity that one could consider to be man's best friend. Thank you very much.

What is being claimed is:

1. A unique piece of engineering device “BT' Smart Machine” (BTSM) which has lawn mowing, leaf blowing, snow blowing, vertical and horizontal trolley capabilities and other functionalities such as a compressor, car battery jump-starter/charger, and AC/DC outlets.

2. BTSM of claim 1 in the above said process whereby it initially marks and tracks the fields into a virtual 3D map via marking and tracking devices.

3. BTSM of claim 1 wherein an inbuilt onboard universal remote control facilitates the opening and closing of doors like the garage door for instance when navigating your premise.

4. BTSM of claim 1 wherein it is ergonomically designed to be anti-side-flip/anti-upside-down-flip and to the design and process whereby it gets back onto its feet as depicted in FIGS. 13(a) to 13(j) and FIGS. 12(a) through 12(l).

5. BTSM of claim 1 and to the process wherein it uses safety and security devices such as led lights, alarms, sensors, front/rear view digital cameras, and the GPS/satellite systems in order to make it virtually theft proof.

6. BTSM of claim 1 and to the process wherein an alternate wheel/traction device is equipped with retractable treads to enhance traction and prolong tire life as depicted in FIGS. 28(a) through 29(b).

7. BTSM of claim 1 and to the process wherein pre-programmed/programmable features tells it whether to mow the lawn, spray grass treatment, blow the leaves, blow the snow and what designs to cut on the lawn.

8. BTSM of claim 1 and to the process wherein the wheel system actuate in/out as needed and function simultaneously or independently to help facilitate quicker turns and provide stability, balance, and maneuverability.

9. BTSM of claim 1 and to the process wherein it can be remotely operated via a wireless remote control which has a digital LCD readout display and the above said extra functionalities.

10. BTSM of claim 1 and to process whereby it has other functionalities as the above said high-powered air compression, a heavy duty retractable car jumper/charger, four AC outlets and retractable male/female DC outlets as depicted in FIG. 2 labels 31 through 34.

11. BTSM of claim 1 and to the above said process whereby it functions as a makeshift high-power turbine fan as depicted in FIGS. 14(a) through 14(d).

12. BTSM of claim 1 and to the above said process whereby the actuator arms (of FIGS. 2 and 3 labels 11 to 18) have both intake (vacuum) and outtake (blower) capabilities and also function as both a way to evacuate substances such as mulched grass and also as a way to spread/spray grass treatment.

13. BTSM of claim 1 and to the process whereby it runs off of solar power while saving and replenishing battery life.

14. BTSM of claim 1 and to the process whereby the shield is capable of a linear upward and downward actuation (aides in cutting grass to a precise height) and a 360 degree pivot/rotation incase it flips upside down.

15. BTSM of claim 1 and to the above said process wherein the main Chassis FIG. 2 label 1 is capable of an upward/downward linear actuation.

16. BTSM of claim 1 and to the process wherein special four bladed turbines as depicted in FIG. 3 label 30 mulch grass (may require multiple blades) into dust.

17. BTSM of claim 1 and to the process whereby the handles (equipped with an onboard mini-remote control) as depicted in FIG. 8(b) labels 8 and 9 manually and/or automatically retract in and out for an easy operation.

18. BTSM of claim 1 and to the special recharging base as depicted in FIGS. 26 and 27 whereby it can swivel BTSM from a horizontal charge-back position to a space saving vertical charge-back position.

19. BTSM of claim 1 and to the process whereby FIG. 23 labels 25 attaches to it such that it now functions as not just a vertical trolley, but also a horizontal trolley.
